(19) United States
(12) Patent Application Publication
(10) Pub. No.: US 2010/0330320 A1
(43) Pub. Date: Dec. 30, 2010

(54) Self-adhering resin applique and method

(76) Inventor: Sharin Ann Louis, Mesa, AZ (US)

Correspondence Address: SHARIN A. LOUIS, 2252 S. ESTRELLA, MESA, AZ, 85202, US

(21) Appl. No.: 12/803,515

(22) Filed: Jun. 28, 2010

Related U.S. Application Data
(60) Provisional application No. 61/269,905, filed on Jun. 29, 2009.

(51) Int. Cl. C09J 7/02

(52) U.S. Cl. 428/41.8

(57) ABSTRACT

An embodiment to be applied to any hard surface to create a decorative appearance, comprising of a decorative and a flat bottom surface. The application method comprised of peeling the backing paper off of an adhesive-coated bottom surface of the embodiment, and pressing the rear surface of the embodiment toward a selected area of the surface to apply. Some advantages of the self-adhering decorative resin applique in lieu of what is currently available is its superior durability and flexibility over the traditional composition due to its nature of the unique material utilized and additionally their self-adhesive backing which makes them convenient and quick to apply.

### CROSS-REFERENCE TO RELATED APPLICATIONS

This application claims benefit of priority under 35 U.S.C. §119(e) to co-pending U.S. Application Ser. No. 61/269,905 filed by the same inventor on Jun. 9, 2009 under the same title.

### BACKGROUND OF THE INVENTION

1. Technical Field

The present invention generally relates to an apparatus for applying to a surface to create a decorative appearance.

2. Background Art

There have been many devices and methods for adding decorative appearances to surfaces of objects such as furniture, doors, walls, etc. The use of traditional composition ornaments dates back to the 1500's. Historically, hand-carved wooden or stone ornaments were used throughout European architecture and in the U.S. In later developments, composition ornaments made of plaster or clay gained popularity because of the ease of molding intricate designs as compared to carving them from wood.

Traditional stone, wood or clay ornamentations suffered from a degree of deterioration and damage due to the climate conditions on both the composition material and the wood material. Additionally, clay composition ornaments are brittle and fragile. Furthermore, they must be steamed in order to be temporarily pliable for adhering to surfaces such as furniture. Alternatively, they can be glued or set with small nails.

Thus, conventional approaches for decorative appliqués has several disadvantages and there is a need for appliqués which are easy and inexpensive to manufacture, have good strength and flexibility and can be permanently applied with little effort.

### BRIEF DESCRIPTION OF THE DRAWINGS

FIG. 1 is a self-adhering resin applique according to one exemplary embodiment of the invention;

FIG. 2 is a side view of a self-adhering resin applique according to one exemplary embodiment of the invention;

FIG. 3 is a self-adhering resin applique according to another exemplary embodiment of the invention;

FIG. 4 is a side view of a self-adhering resin applique according to another exemplary embodiment of the invention; and

FIG. 5 is a side view of a self-adhering resin applique of the invention in use.

### DETAILED DESCRIPTION OF THE INVENTION

Self-adhering resin appliques that remains pliable and flexible after being cured without having to be steamed or processed in any other manner before applying them to a surface to be decorated. Further, the resin used in the inventive embodiments has reasonable degree of porosity which makes them very suitable for staining or painting prior to or after application to be desired.

Anyone who has ever walked through historic houses and large public buildings, visited an art gallery, picked up a picture frame in an antique shop, or even ridden an old carousel has been close to composition ornaments, but has probably not known what they were or how they were made. This is not surprising, since composition or “compo” was conceived as a substitute for more laboriously produced ornamental plaster and carved wood and stone, so was intended to fool the eye of the viewer. The confusion has been heightened over time by makers who claimed to be the sole possessors of secret recipes and by the variety of names and misnomers associated with the material, including plaster, French Stucco, and Swedish Putty, to name a few.

Many natural or man-made materials can be made soft or “plastic” by the application of heat and are called “thermoplastics”. It is soft and pliable when pressed into molds, becomes firm and flexible as it cools and becomes rigid and hardened when it is cured to room temperatures. Typically formulated with chalk, resins, glue, and linseed oil, these combination of materials gives compo ornamentations their familiar light-to-dark brown color.

Generally adhered to wood, conventional composition ornaments are most often found decorating flat surfaces such as interior cornice and chair rail moldings, door and window surrounds, mantelpieces, wainscot paneling, and staircases, anywhere that building designers and owners wanted to delight and impress the visitor, but stay within a budget. While traditional composition ornaments were less expensive than carved ornaments, they are still difficult to make and apply and thus, used only for “high style” interiors. Thus the types of structures historically decorated with composition ornaments were more democratic, encompassing residential, commercial and institutional buildings, and including specialty applications such as the social saloon of a steamship.

While various types of moldable composition date back many years, the recipes for these compositions have historically been overly complicated and often kept secret. They have been known to comprised of a few basic ingredients: animal glue, oil (usually linseed), a hard resin) pine rosin or pitch was cheapest), and a bulking or filling material, generally powdered chalk or whiting in solid form. It is a type of white, soft limestone.

Compo mixes have been the subject of a good deal of variation and there has never been a set recipe, but the ornament manufacturers of the later 18^{th} and early 19^{th} centuries understood in general terms what their material was and what it could do. In brief, compo is perhaps best understood as an early thermoplastic that allowed the rapid reproduction of complicated detail for popular use. Composition could be carved to heighten detail, correct defects, or undercut ornaments that were, of necessity, straight-sided-so that they would release from the rigid molds. This could be done in the gelled state or, with more difficulty, after it had finally hardened to stone-like solidity.

The Arts and Crafts and related styles, such as the more decorative Art Nouveau, were well rooted in America by the beginning of the century. Pitch molds made from relief-carved patterns had become common in America. A uniquely 20^{th} century application of composition ornament was in the lavishly decorated movie palaces of the Depression era. As interest in architectural embellishments declined, particularly as a result of the post-World War II styles, so did the composition trade. Many old firms went out of business and their molds were dispersed or destroyed. The few that remained concentrated on restoration projects or were sustained by diversification into other materials. By the 1950's and 60's composition as a material and craft had been all but forgotten. An upsurge in hand craft production that started in the late 60's and has continued to the present—as well as increasing interest in historic preservation—has led to the renewed study of old methods and materials, including composition.

According to various embodiments of the present invention, a device and process for making the same, may include forming an appliqué in a desired decorative mold using a silicon resin material and applying a self sticking adhesive surfaces to a back side of the appliqué. The result is a decorative resin appliqué which is flexible, durable readily paintable or stainable ornamentation that may be applied without heating, steaming, gluing or nailing required.

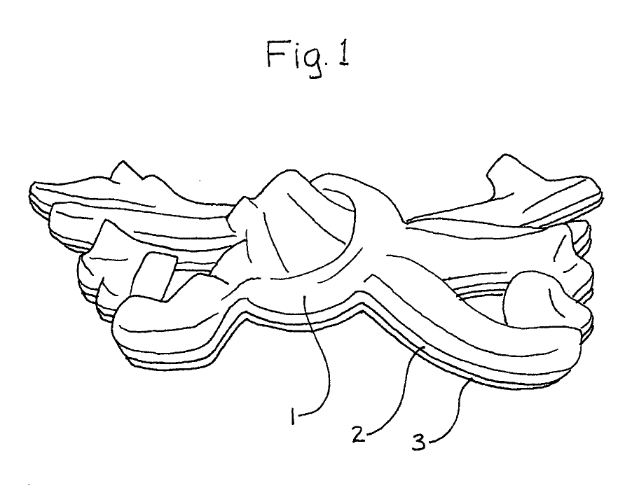

FIG. 1 is the angle view with (1) being the applique and (2) the 3M double-sided adhesive sticky tape, (3) the easy peel-away coating.

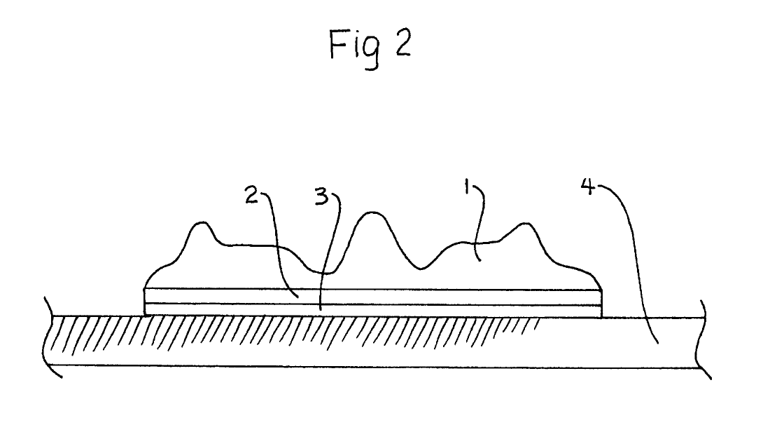

FIG. 2 is the side view showing (1) being the applique; (2) the 3M double side adhesive tape, and (3) the easy peel away coating, (4) being the mounting surface.

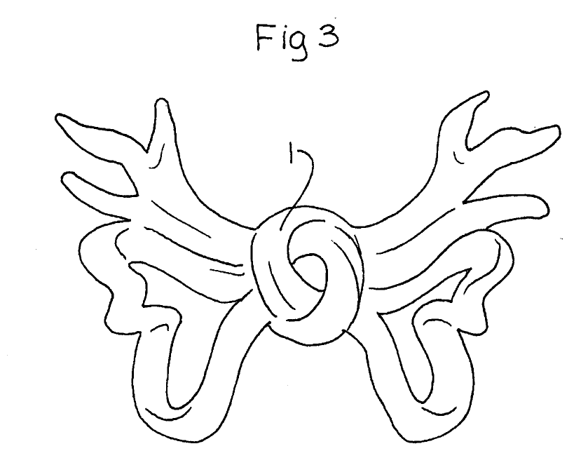

FIG. 3 is the top view of the applique showing only (1) which is the applique.

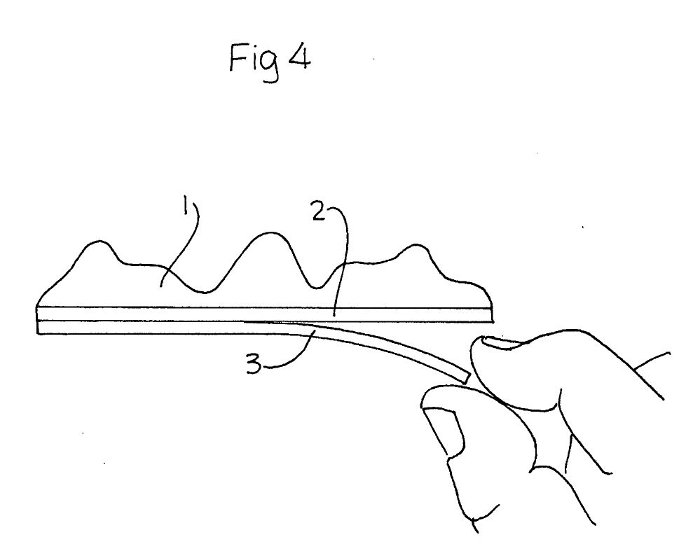

FIG. 4 is a side view showing (1) the applique, (2) the 3M double sided adhesive tape, (3) which is the easy peel away coating being peeled away.

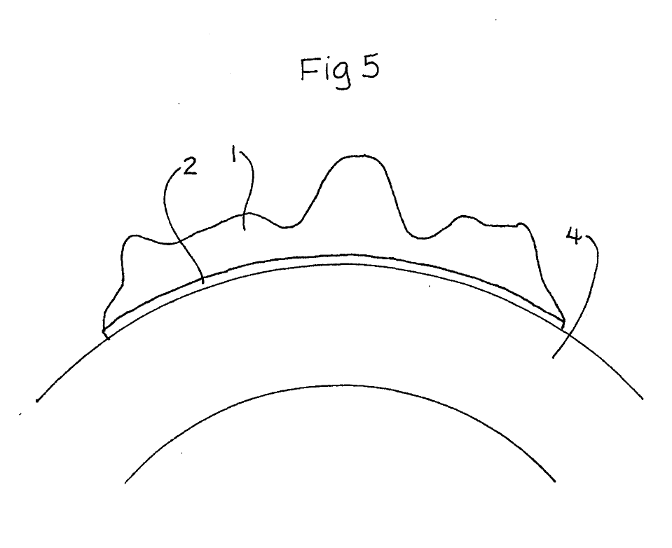

FIG. 5 is a side view of a curved surface with the applique in place, showing (1) being the applique, and (2) is the 3M double sided sticky adhesive, with part (4) being the mounting surface-like the curved front of a dresser.

Generally a process of the inventive embodiments may include, building a mold for the decorative appliqué, pouring a liquid resin into the mold, and applying an adhesive to a back of the molded appliqué.

A more detailed method of building an appliqué mold according to embodiments of the present invention include building a four-sided wood laminate (or other suitable material) frame that is dimensioned for the appliqué to be molded. Place an existing appliqué, of a design that is desired to make a mold of, onto the center of the base of the laminate wood frame. Pour a liquid plastic or rubber material, such as the PlatSil 71 series mold mixture, over the original appliqué and into the laminate wood frame. It may be necessary to mix components from two separate PLatSil 71 Series RTV Liquid Silicone Rubber Part A and Part B of a pre-determined mixed ratio. It may be desirable to ensure there is at least ¾ of an inch of mixture above the highest point of the appliqué when pouring PlatSil 71 Series mixture into the frame. Cure time is approximately four to five hours. Remove the original appliqué from the newly created mold.

A decorative resin appliqué casting process may then be performed by mixing components from two separate Poly Plasti-Flex Liquids Part A and B of a pre-determined mixed ratio and pouring the mixture into the mold. It should be recognized that a similar resin or other liquid plastic/rubber material may also be used that may or may not require mixing. The Poly Pasti-Flex provides certain advantages such as: safe and easy to machine (contains no silica), reproduces fine detail, variable working time, tough and hard plastic while flexible and not brittle. When removing the cured resin appliqué from the mold, carefully pull the new appliqué casting away from the rubber mold. Inspect and trim the applique edges either with small scissors or by slightly sanding any overlaps or rough edges where needed.

They newly formed appliqué may then be coated with an adhesive for final preparation. In one embodiment, appliqués may be placed uniformly on an 8½″×11″ Acrylic Foam Tape sheet such as 3M® VHB Acrylic Foam Tape 4905. They are traced and then the patterns may be cut out individually. Remove the clear adhesive backing of the acrylic foam tape and carefully align the adhesive tape when applying to the back of the appliqué. Gently apply pressure and smooth out any air pockets that are apparent and trim any excess tape around the appliqué edges. In other embodiments, a layer of adhesive and/or plastic backing material may be applied while the appliqué is still in the mold or using a different material. Variations in the application of adhesive will depend on the manufacturing processes desired.

Some advantages of the self-adhering decorative resin appliqués of the present invention are the superior durability and flexibility over the traditional composition. This is largely due to the liquid resin material which they are made from. They further have a self-adhesive backing which makes the appliqué convenient and fast to apply to most clean dry surfaces.

Self-adhesive resin appliqués are unique to what is currently available. They are made from a mixture of liquid resin material that remains pliable and flexible after being cured without having to be steamed or processed in any other manner before applying them to a surface to be decorated. Further, the liquid resin used in the inventive embodiments has a reasonable degree of porosity which makes them very suitable for staining or painting prior to or after application to the desired surface.

Technical information for best mode uses:
PlatSil 71 Series RN Liquid Silicone Rubber-molding agent
Poly Plasti-Flex Liquid Plastic Description-casting agent
3M VHB Acrylic Foam Tape 4905-adhesive backing material

PlatSil 71 Series RTV Liquid Silicone Rubber Description

PlatSil 71 Series RN Liquid Silicone Rubber is High Tear Strength and Flexible. PlatSil 71-20A is Blue in Color. Chemical Family: Organofunctional-siloxanes. PlatSil 71-20B is Pink in Color. Chemical Family: Silicone PlatSil 71 Series RN Liquid Silicone Rubber is 2 component, addition-cure, and platinum-catalyzed, flexible molds compounds. They are mold materials utilized for casting polyurethane resins.

Mixing and Curing Silicone Rubber

Carefully weigh Part B then Part A and in proper 1-1 ratio into a clean mixing container. Accurate weighing is important to obtain the optimum physical properties from the cured rubber. Mix thoroughly, scraping sides and bottom of the container. Once mixed together PlatSil 71 series Parts A and B will cure and become harder at room temperature.

Feature and Benefits

Mix ratio 1-1

Room Temperature Cure

Easy release properties

High Tear Strength

Good Chemical Resistance for longer life

Low/zero shrinkage for dimensional reproduction

Creating a Rubber Mold with PlatSil 71 Series

Build a four sided wood laminate frame that is sized for the required dimension for the appliqué casting. The inventor found use of a hot glue gun works well to secure the back of the original appliqué to the center of the base of the laminate wood frame. This helps to ensure that the appliqué does not move while pouring the PlatSil 71 Series over the appliqué. PlatSil Part A and B mixture should be poured into a laminate 4 sided wood frame that is sized for the required dimensions of the appliqué casting. It may be desirable to ensure that there is at least ¾ of an inch above the highest point of the appliqué when pouring the PlatSil 71 Series mixture into the mold. Cure time is approximately four to five hours.

Poly Plasti-Flex Liquid Plastic Description

Poly Plasti-Flex Liquid Plastic is used to produce decorative moldings, models, patterns, fixtures and more. This product reproduces minute detail from molds and can be drilled, sanded and nailed. Poly Plasti-Flex is two component, part A and Part B. Part A appearance: Clear Brown Liquid and Part B appearance: Off White Liquid. Part A Chemical Family: Methylene bis (phenylisocyanate) and Part B Chemical Family: Blend of polyos and other trade secret ingredients. Only part B needs stirring.

Mixing and Curing Plasti-Flex Liquid Resin

Gentle mixing of Part A and B is all that is required. Use metal or plastic spatulas to avoid introducing moisture with paper or wood tools. Mixing ratio by weight is approximately 35 g Part A to 100 g Part B. Combined proper amounts of A and B in a clean mixing container. Mix well thoroughly scraping sides and bottom for 1 minute. Pour into properly prepared appliqué mold as soon as possible after mixing. Leave the resin mixture in the appliqué mold until thoroughly cured. Demold may be removed 15-30 minutes at room temperature.

Feature and Benefits

Safe and easy to machine (contains no silica)

Reproduces fine detail

Variable working time

Touch and hard plastic, but not brittle

Procedures when removing Appliqué from Mold

When removing the resin appliqué from the mold, I carefully pull the appliqué casting away from rubber mold. Trim the appliqué edges by slightly sanding edges where/if needed.

3M VHB Acrylic Foam Tape 4905 Product Description

Acrylic Foam Tape 4905 is a clear acrylic VHB Double Sided Tape. It is colorless making it ideal for bonding materials or for applications where a colored bond line is unacceptable. This tape has somewhat lower peel, tensile and shear performance than most other VHB due to their inherent softness.

Physical Properties

Adhesive Type: Acrylic

Thickness: Tape 0.50 mm
Liner 0.013 mm
Total 0.63 mm

Density: 960 kg

Release Liner: Filmic (Red)

Tape Color: Clear

Performance Characteristics

Surfaces: This product bonds to high energy surfaces such as glass, acrylic and metals.

Application Techniques

Bond strength is dependent upon the amount of adhesive-to-surface contact developed. Firm application pressure develops better adhesive contact and improves bond strength. To obtain optimum adhesion, the bonding surfaces should be clean and dry. 3M Acrylic VHB Foam Tape 4905 is suitable for bonding a variety of substances, including sealed wood, many plastics, composites and metals.

It should be noted that the self-adhering resin appliqués of the present invention may be formed in substantially any desired shape or size. The processes of the inventive embodiments enable accurate reproduction of high quality, flexible and durable appliqués which are inexpensive to produce as compared with traditional techniques. While specific materials have been disclosed above, the skilled artisan will recognize that other suitable materials and processes may be used without departing from the scope of the inventive embodiments.

Unless contrary to physical possibility, the inventor envisions the components of respective embodiments may be combined in any manner.

Although there have been described preferred embodiments of this novel invention, many variations and modifications are possible and the embodiments described herein are not limited by the specific disclosure.

What is claimed is:

1. An applique, decorative three dimensional in configuration for application to furniture or any hard smooth surface comprising of resin material that remains durable and flexible having an upper surface and a bottom surface, the upper surface having a decorative appearance and said bottom surface having a self-adhesive portion, said applique having a releasable surface whereby said self-adhesive portion may be peeled and adhesively applied, bond strength is dependent upon the amount of adhesive-to-surface contact developed.

2. The applique in accordance with claim 1, wherein said the embodiment has a colorless acrylic double sided self-adhesive foam tape backing making it ideal for bonding to a hard surface or for applications where a color bond line is unacceptable

3. The applique in accordance with claim 2, wherein said the embodiment, appliques are made from a mixture of resin material that remains pliable, flexible and stainable.

4. The applique in accordance with claim 3, wherein said applique is opaque.
